(19) United States
(12) Patent Application Publication
(10) Pub. No.: US 2025/0015886 A1
(43) Pub. Date: Jan. 9, 2025

(54) SIGNAL QUALITY MONITORING METHOD

(71) Applicant: Telefonaktiebolaget LM Ericsson (publ), Stockholm (SE)

(72) Inventors: Roberto MAGRI, Genova (IT); Davide SANGUINETTI, Genova (IT); Riccardo CECCATELLI, Genova (IT)

(21) Appl. No.: 18/711,789

(22) PCT Filed: Nov. 30, 2021
(86) PCT No.: PCT/EP2021/083658

§ 371 Date: May 20, 2024

(51) Int. Cl. H04B 10/079

(52) U.S. Cl. CPC H04B 10/0793; H04B 10/0795

(57) ABSTRACT

Signal quality monitoring methods and systems. A signal quality monitoring method includes receiving, at a termination point of an optical link, an incoming transmission including one or more optical signals. The method further includes filtering a portion of the incoming transmission to select an optical signal from the one or more optical signals. The method also includes segmenting the optical signal by time to obtain a plurality of optical signal time segments, and generating a signal analysis plot using the plurality of optical time signal segments.

### TECHNICAL FIELD

Embodiments described herein relate to signal quality monitoring methods and systems, in particular signal quality monitoring methods and systems for monitoring optical signals and generating signal analysis plots.

### BACKGROUND

In current hardware units, such as packet switching equipment and antenna array systems of the type commonly used in telecommunications networks, optical transmission is a frequently used way to implement high bandwidth data transmission. In order to ensure correct operation of optical transmission and reception systems, it is useful to be able to analyse the quality of signals sent and received. In this way, potential issues with signal transmission/reception can be swiftly identified and periods of low capacity operation or inactivity due to fault identification and resolution can be reduced relative to systems without quality of signal analysis capabilities. Automatic diagnostic capabilities, root cause analysis capabilities and preventive maintenance support can all help to reduce periods of reduced or zero system operation capabilities.

When performing signal quality analysis, signal analysis plots may be used to allow quick comparisons between different signals, and to support the rapid identification of issues with signals. Various types of signal analysis plots may be suitable in different systems, including those generated by optical or electrical spectrum analysers, optical time domain reflectometry plots used to check fibre integrity, and so on. Of particular use in analyses of transceiver and transmission quality are eye diagrams (also referred to as eye patterns). Eye diagrams are generated by repeatedly sampling a digital signal, with the binary output plotted on the y axes of eye diagrams and the data rate plotted on the x axes. The resulting diagram shows the superposition of different analog waveforms corresponding to different bit patterns. From the eye diagram various forms of signal impairment information can be derived, including information on transmitter distortion effects; bandwidth limitations; time jitter; optical fibre dispersion; noise; and so on.

Typically, when it is desired to obtain signal quality measurements, an engineer will be deployed to the location of the relevant optical transmission/reception system and will take measurements by connecting dedicated monitoring equipment to the optical system. This process for obtaining signal quality measurements may be both time and labour intensive. Recent developments in optical systems have attempted to mitigate the time and labour costs associated with signal analysis plot generation by providing additional capabilities within optical systems. Field Programmable Gate Arrays (FPGA) and/or Integrated Circuits (IC) may include in their Serialiser/Deserialiser (SERDES) the capability to generate signal analysis plots, such as eye diagrams, by adjusting the sampling phase and the decision threshold with sub-bit resolution at an auxiliary electrical path extracted from the main signal. An example of a FPGA having the capability to generate eye diagrams is discussed in “Leveraging 7 Series FPGA transceivers for High-Speed Serial I/O Connectivity” by Fu, H of Xilinx, WP431 V1.0, available at https://www.xilinx.com/support/documentation/white_papers/wp431-Trans-Serial-Connectivity.pdf as of 17 Nov. 2021.

Typically, optical system FPGAs are connected to optical pluggable modules (for example, small form-factor pluggable transceivers, SFPs) which have internal amplifiers. These internal amplifiers commonly act to alter the nature of the received analog signal, for example, to convert the analog signal into a digital signal. If a received optical signal passes through an optical pluggable module prior to reaching a FPGA, any signal analysis plots generated by the FPGA may not accurately represent the properties of the optical signal as originally received. Accordingly, any signal analysis plots generated may be of limited use for analysing the quality of the optical transmission line over which the optical signal arrived.

### SUMMARY

It is an object of the present disclosure to provide methods and systems that support the capabilities of optical system FPGAs, ICs and so on to generate optical signal analysis plots. In particular, it is an object of the present disclosure to provide methods and systems that allow optical signal analysis plots to be generated while avoiding the distorting impact of internal amplifiers and similar components.

An embodiment of the present disclosure provides a signal quality monitoring method for optical signals. The method comprises receiving, at a termination point of an optical link, an incoming transmission comprising one or more optical signals. The method further comprises filtering a portion of the incoming transmission to select an optical signal from the one or more optical signals. The method also comprises segmenting the optical signal by time to obtain a plurality of optical signal time segments. The method further comprises generating a signal analysis plot using the plurality of optical time signal segments.

In some embodiments, the step of generating the signal analysis plot may further comprise obtaining multiple instances of the plurality of optical signal time segments, the multiple instances of the plurality of optical signal time segments being obtained from different instances of the optical signal separated by time in the incoming transmission. The generating step may further comprise processing the multiple instances of a given optical signal time segment to generate a processed optical signal segment, and combining the processed optical signal segment with other processed optical signal segments to generate the signal analysis plot. The processed optical signal segment may be generated by combining the multiple instances of the corresponding optical signal time segment, and deriving an averaged optical signal time segment as the processed optical signal segment.

In some embodiments, the segmenting of the optical signal by time and generation of the signal analysis plot may be performed at a FPGA. The FPGA may receive the portion of the incoming transmission via a dedicated monitoring port, and the portion of the incoming transmission may be a monitoring portion.

In some embodiments a further portion of the incoming transmission may be received by the FPGA via one or more signal ports. The further portion may be used to provide a reference clock signal for use in the generation of the signal analysis plot.

A further embodiment of the present disclosure provides a signal quality monitoring system for optical signals. The signal quality monitoring system comprises processing circuitry, one or more interfaces and a memory containing instructions executable by the processing circuitry. The signal quality monitoring system is operable to receive, at a termination point of an optical link an incoming transmission comprising one or more optical signals. The signal quality monitoring system is further operable to filter a portion of the incoming transmission to select an optical signal from the one or more optical signals. The signal quality monitoring system is also operable to segment the optical signal by time to obtain a plurality of optical signal time segments. The signal quality monitoring system is further operable to generate a signal analysis plot using the plurality of optical time signal segments.

### BRIEF DESCRIPTION OF DRAWINGS

The present disclosure is described, by way of example only, with reference to the following figures, in which:—

FIG. 1 is a flowchart showing a signal quality monitoring method according to embodiments;

FIG. 2A and FIG. 2B are schematic diagrams of signal quality monitoring systems in accordance with embodiments;

FIG. 3 is a diagram showing an example of how an optical signal or electrical signal may be segmented in accordance with embodiments;

FIG. 4 is a schematic diagram showing an overview of a portion of a communication network in which a signal quality monitoring system in accordance with embodiments may be implemented;

FIG. 5 is a schematic diagram of an example signal quality monitoring system implementation in accordance with embodiments;

FIG. 6 is a schematic diagram of a FPGA in accordance with embodiments;

FIG. 7 is a flowchart showing how an eye diagram may be generated in accordance with embodiments;

FIG. 8 is a plot illustrating the eye diagram generation process of FIG. 7; and

FIG. 9A and FIG. 9B are example simulated signal analysis plots in accordance with embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

In order to support the capabilities of optical system to generate optical signal analysis plots (using FPGAs, ICs and so on) while avoiding the distorting impact of internal amplifiers and similar components, it is desirable to support the transmission of received optical signals to components that can measure the signal properties without the received optical signals having previously passed through a component that may distort the signal (such as an internal amplifier of a SFP, as discussed above). Accordingly, in some embodiments, a portion of a received optical signal (which, in some embodiments, may be all of the received optical signal) may be sent to measuring components along an optical path that avoids components which may distort the signal properties. Further, the portion of the optical signal may be processed to reduce the impact of noise and support the generation of high-quality signal analysis plots.

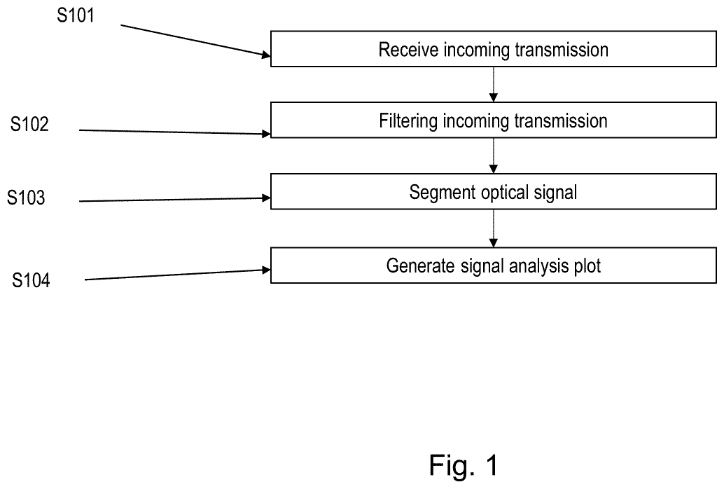

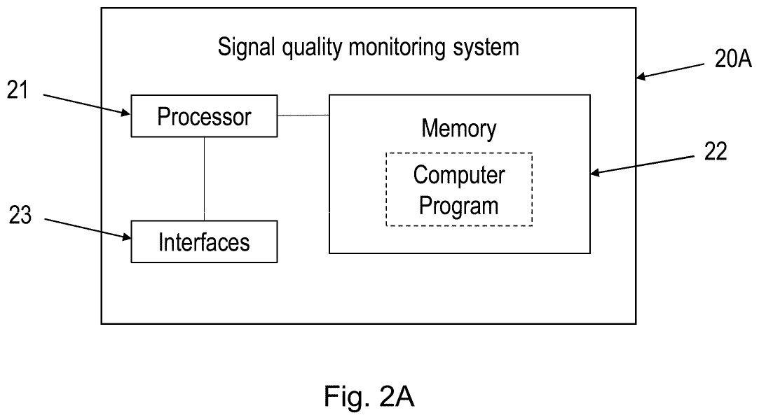

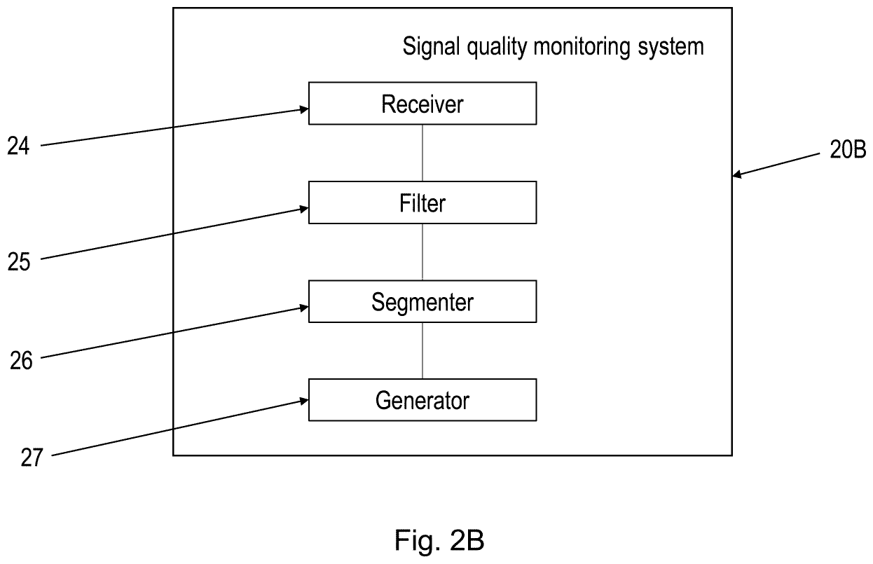

FIG. 1 is a flowchart showing a signal quality monitoring method according to embodiments. FIG. 2A and FIG. 2B are schematic diagrams showing signal quality monitoring systems 20A and 20B (collectively, 20) in accordance with embodiments. The signal quality monitoring systems 20A, 20B are examples of signal quality monitoring systems that may perform the method of FIG. 2.

In step S101 of the FIG. 1 method, an incoming transmission comprising one or more optical signals is received at a termination point of an optical link (for example, at the end of a fibreoptic cable). In some embodiments, a plurality of optical signals that may be wavelength division multiplexed (WDM) optical signals are received in the incoming transmission; in other embodiments a single optical signal may utilising one wavelength or range of wavelengths may be received. The reception of the incoming transmission may be performed, for example, by the signal quality monitoring system 20A in which the processor 21 runs a program stored on the memory 22 and utilises the interfaces 23 (which may include an optical signal termination point) to receive the optical signals, or may be performed by the receiver 24 of signal quality monitoring system 20B.

Following the reception of the incoming transmission at the termination point of the optical link, a portion of the incoming transmission is filtered to select an optical signal from the one or more optical signals, as shown in step S102 of FIG. 1. Where a plurality of optical signals that are WDM optical signals are received, the filtering may be done on the basis of wavelength. Where the plurality of optical signals differ in some other way, alternative filtering may be used; as an example of this, where the plurality of optical signals differ from one another by phase, the filtering may be done on the basis of phase. Where only a single optical signal is received, the filtering may simply select this optical signal. The filtering of the portion of the incoming transmission may be performed, for example, by the signal quality monitoring system 20A in which the processor 21 runs a program stored on the memory 22 and utilises the interfaces 23 (which may include an optical filter) to filter the portion of the incoming transmission, or may be performed by the filter 25 of signal quality monitoring system 20B.

The portion of the incoming transmission that is filtered to select an optical signal may, in some embodiments, be the entirety of the incoming transmission (that is, the portion may comprise 100% of the power of the incoming transmission). However, typically the portion of the incoming transmission is less than 100% of the incoming transmission, such that a further portion of the incoming transmission exists that is not filtered to select the optical signal. The portion of the incoming transmission that is filtered to select the optical signal may be referred to as the monitoring portion. The monitoring portion may be split from the incoming transmission using, for example, an optical tap. In some embodiments, the monitoring portion comprises a small percentage of the available power of the incoming transmission; by way of example, the monitoring portion may comprise 5% of the available power of the incoming transmission. Where a further portion of the incoming transmission exists, this further portion may comprise a larger percentage of the total power of the incoming transmission; continuing with the example referred to above where the monitoring portion comprises 5% of the available power of the incoming transmission, the further portion may comprise the remaining 95% of the available power.

In some embodiments, the portion of the incoming transmission that is filtered to select an optical signal may be received by a component that is to perform the segmenting of the optical signal; this component may be a FPGA or IC, for example. The portion of the incoming transmission may be received after filtering to select an optical signal, in which case only the selected optical signal may be received by the component. Alternatively, the portion of the incoming transmission may be received prior to the filtering, in which case the component may comprise a filter to perform the filtering. Where the portion of the incoming transmission is a monitoring portion, this monitoring portion may be received by the component at a dedicated monitoring port; if a further portion of the incoming transmission is also to be received by the component, the further portion may be received via one or more signal ports separate from the monitoring port.

Where a monitoring portion has been received by a component (and, if not already done before reception by the component, has been filtered), the monitoring portion may be converted using an optical to electrical transceiver. The optical to electrical transceiver receives the monitoring portion (an optical signal) and converts the monitoring portion into an electrical signal. The electrical signal may then be amplified using a linear amplifier; amplification of the electrical signal may be of particular use where the monitoring portion comprises a small percentage of the available power of the incoming transmission (for example, 5%) and therefore the power of the optical signal obtained from the monitoring portion is low. Alternatively, the electrical signal obtained from the optical to electrical transceiver may not be amplified.

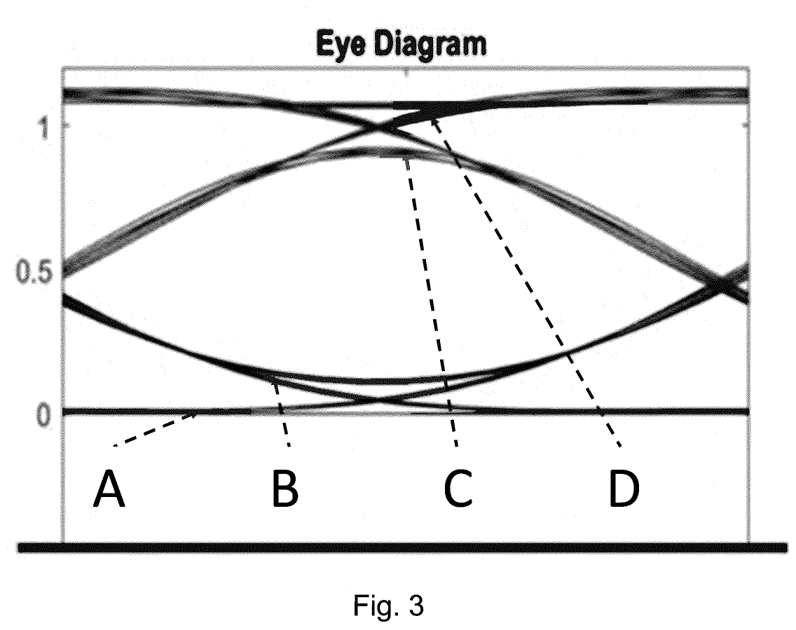

The optical signal is then segmented by time to obtain a plurality of optical time signal segments, as shown in step S103 of FIG. 1. Where the monitoring portion has been converted into an electrical signal as discussed above (and, optionally, the electrical signal has been linearly amplified), the segmentation may be performed on the electrical version of the optical signal. FIG. 3 shows an example of how an optical signal (or the electrical version of the same) may be segmented. An example signal analysis plot, specifically an eye diagram, is shown in FIG. 3. Although the signal analysis plot would not be available at this point in the signal quality monitoring method, this is a useful way to illustrate the segmentation of the optical signal. The y axis of FIG. 3 indicates whether the signal represents a binary 1 or 0, while the x axis plots time. Where the eye diagram represents the optical signal as a whole, as indicated in FIG. 3, the signal may be segmented into a plurality of optical signal segments. In the example shown in FIG. 3, the number of segments is 4; larger or smaller numbers of segments may be used in other examples. The 4 segments in FIG. 3 are labelled A, B, C and D. The optical signal as a whole may be obtained by combining the 4 segments. A more detailed discussion of an example segmentation process in accordance with some embodiments can be found below. The optical time signal segments may also be referred to as bit patterns. The segmentation of the optical signal may be performed, for example, by the signal quality monitoring system 20A in which the processor 21 runs a program stored on the memory 22 to segment the optical signal, or may be performed by the segmenter 26 of signal quality monitoring system 20B. In some embodiments, the segmenter 26 or processor 21 and memory 22 may form part of a FPGA or IC, for example.

When the segmentation of the optical signal has been performed, the method then further comprises utilising the plurality of optical time signal segments to generate a signal analysis plot (for example, an eye diagram), as shown in step S104 of FIG. 1. In some embodiments, the signal analysis plot may be generated by recombining the segments (bit patterns) obtained from a single instance of the optical signal; returning to the example illustrated by FIG. 3, by recombining segments A, B, C and D. However, where the signal analysis plot is generated using segments from a single instance of the optical signal, the benefits obtained via the segmentation process may be reduced relative to implementations using multiple instances of the optical signal segments.

In further embodiments, the segmentation process may be utilised to help mitigate the impact of noise on the generated signal analysis plot. In order to help mitigate the impact of noise, the process of generating the signal analysis plot in accordance with some embodiments comprises obtaining multiple instances of the plurality of optical signal time segments (bit patterns). The multiple instances of the plurality of optical signal time segments may be obtained from different instances of the optical signal separated by time in the incoming transmission; with reference to FIG. 3, the obtained segments may comprise multiple instances of segment A (each segment instance being from a different optical signal), multiple instances of segment B, and so on. In an example where 5 instances of the optical signal separated by time in the incoming transmission are used to obtain the segment instances, the obtained instances of segment A may be optical signal time segments A₁, A₂, A₃, A₄ and A₅ (where the subscript indicates the instance of the optical signal from which the segment has been obtained). Equivalent segment instances B₁₋₅, C₁₋₅ and D₁₋₅ may also be obtained. In this example it is assumed that all segment instances from the 5 optical signal instances are obtained, however this is not necessarily the case and some segment instances may be omitted (by way of example, segment instance C₂ may not be obtained). The reasons for omitting a segment instance may include a noisy optical signal instance, for example.

Where multiple instances of the plurality of optical signal time segments have been obtained from different instances of the optical signal separated by time in the incoming transmission, as discussed above, the multiple instances of a given optical signal time segment may then be processed to generate a processed optical signal segment. The processing may comprise, for example, combining the multiple instances of the given optical signal time segment and deriving an averaged optical signal time segment as the processed optical signal segment. In this way the impact of noise may be mitigated relative to the noise impact on any one of the instances. The average may be the mean of the multiple instances (a mean signal segment), or the median of the multiple instances (a median signal segment). In some embodiments instances of the given optical signal segment that are identified as outliers may be excluded from the processed optical signal segment generation process prior to the combining of the instances of the optical signal segment to derive the processed optical signal segment. The exclusion of outliers may be of particular use where a large number of instances of the plurality of optical signal time segments have been obtained, for example, where 1000 instances of the plurality of optical signal time segments have been obtained. Any suitable process may be used to identify outliers, for example, a standard deviation and mean for each optical time signal segment may be obtained and then any instances falling more than two standard deviations from the mean for the segment may be excluded from the processing of the multiple instances of a given optical signal time segment to generate a processed optical signal segment.

Obtaining multiple instances of the plurality of optical signal time segments and combining the same to generate the signal analysis plot may be particularly effective where, for example, a monitoring portion comprises a small percentage of the available power of the incoming transmission and the monitoring portion is processed using a linear amplifier. The linear amplification of the monitoring portion may increase the power of the monitoring portion to a useful level, but any noise on the monitoring portion may be equally increased which may impact the quality of a signal analysis plot generated using said monitoring portion. By processing multiple instances of the plurality of optical signal time segments in accordance with some of the embodiments discussed above, the impact of the noise amplification may be substantially mitigated, and therefore a high quality signal analysis plot may be obtained using a portion of the incoming transmission (the monitoring portion) that comprises only a small percentage of the available incoming transmission power.

In some embodiments where a further portion of the incoming signal (other than the monitoring portion) exists, this further portion may itself be used in the generation of the signal analysis plot. In particular, the further portion may be used to provide a reference clock signal for use in the generation of the signal analysis plot. Where a reference clock signal has been obtained from the further portion, the monitoring portion may be phase aligned with the further portion (reference clock) to increase the accuracy of the subsequently generated signal analysis plot.

When the signal analysis plot has been generated, the plot may then be outputted. In some embodiments, the plot may be outputted to a storage unit for subsequent retrieval (if desired). Alternatively, the signal analysis plot may be outputted to a further apparatus for analysis, for example, where the signal quality monitoring system forms part of a communications network such as a 3^{rd} Generation Partnership Project (3GPP) 3^{rd} Generation (3G), 4th Generation (4G), or 5th Generation (5G) network, the signal analysis plot may be outputted to a core network node for analysis; said analysis may be performed by any suitable system, such as a machine learning agent, as will be understood by those skilled in the art.

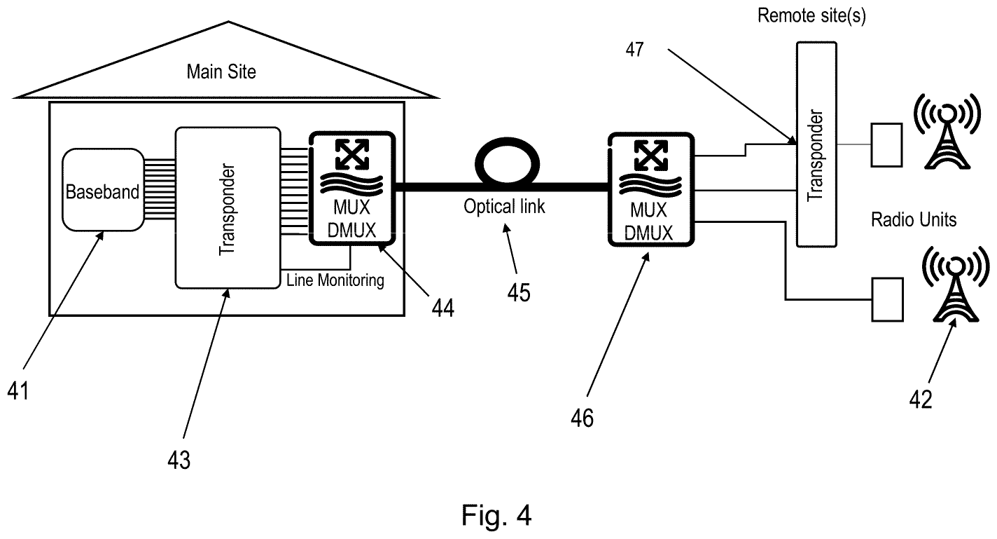

FIG. 4 is a schematic diagram showing an overview of a portion of a communication network (such as a 3GPP 3G, 4G or 5G network) in which a signal quality monitoring system in accordance with embodiments may be implemented. FIG. 4 shows a Centralised-Radio Access Network (C-RAN), in which a baseband unit 41 at a main site is connected to plural remote site(s) radio units (RU) 42 using a WDM fronthaul network. A transponder 43 at the main site generates a plurality of signals using different wavelength ranges, which are aggregated by a multiplexer/demultiplexer (MUX/DMUX) 44 and then sent on a Dense Wavelength Division Multiplexing (DWDM) optical connection 45 to the remote sites. At the remote site, a further MUX/DMUX 46 disaggregates the DWDM signal and the component signals are sent towards different radio units 42 with or without intermediate transponder units 47. Systems in accordance with embodiments may be utilised at one or both of the main site and remote site(s) to support monitoring of the optical connection 45, without requiring the use of additional external equipment. Equally, signals from 3^{rd} party RU at remote sites may be monitored at the main site, which may be of particular value if no intermediate transponder is present to act as demarcation point of the WDM segment.

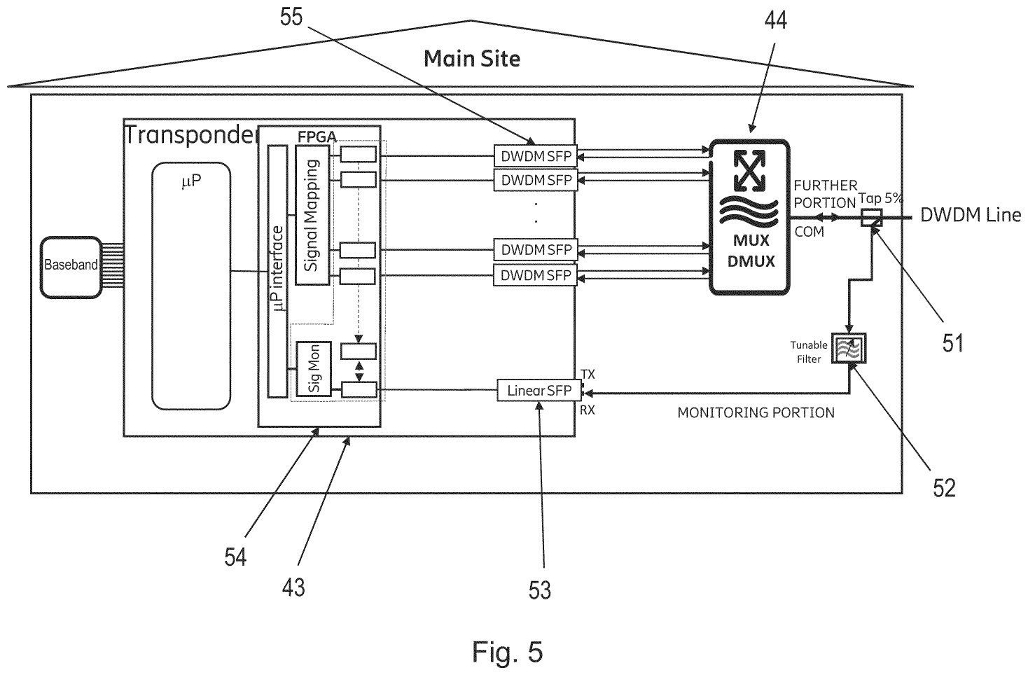

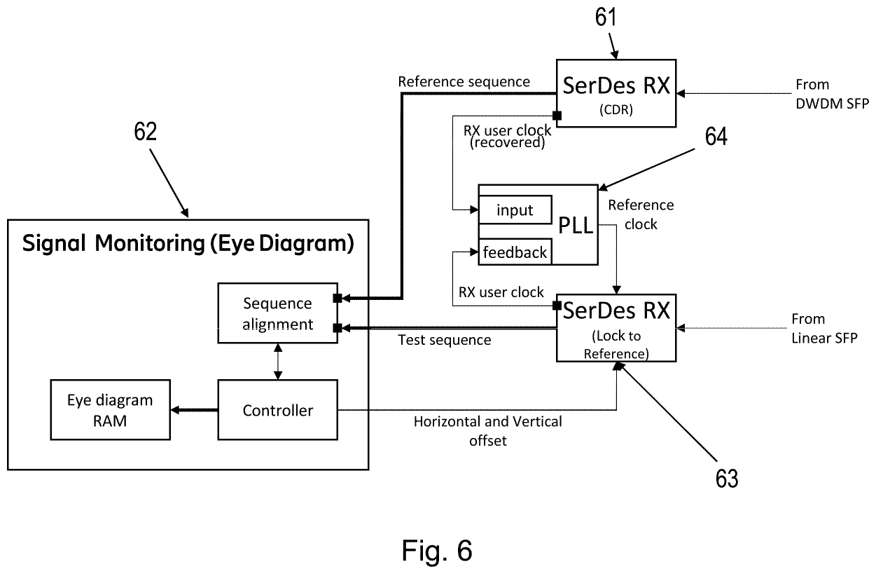

FIG. 5 is a schematic diagram showing in more detail how example signal quality monitoring systems in accordance with embodiments may be implemented. In the example shown in FIG. 5, the signal quality monitoring system is incorporated into the main site architecture; the main site may be as shown in FIG. 4. As can be seen in FIG. 5, in the example signal quality monitoring system shown therein a tap 51 is used to extract 5% of the available power of the incoming transmission as the monitoring portion. The remaining 95% of the available power of the incoming transmission is the further portion; this portion proceeds to a MUX/DMUX unit 44 along the data path. The monitoring portion continues to a tuneable filter 52; in the example shown in FIG. 5 this tuneable filter is located in the monitoring path prior to the monitoring portion being received by a FPGA at a dedicated monitoring port. The tuneable filter is used to select an optical signal from the plurality of optical signals to be analysed; the system shown in FIG. 5 uses wavelength division multiplexing so the filter performs wavelength filtering to select the optical signal. The selected optical signal is then received by a linear SFP 53 (which, in this example, forms part of the transponder 43). The linear SFP converts the input optical signal to an electrical signal, however as the linear SFP does not have an internal limiting amplifier, it may preserve the analogue nature of the incoming signal. In order to implement this, the linear SFP uses photodetection circuitry that has a bandwidth large enough to operate at the same bitrate of the line signals. The linear SFP also does not have an A/D converter. The electrical version of the input optical signal that is output from the linear SFP (which, as explained above, remains analog) is then passed to a FPGA 54. The details of the operation of the FPGA are explained in greater detail below with reference to FIG. 6. The further portion of the incoming transmission is demultiplexed by the MUX/DMUX unit on the data path, then the demultiplexed signals are each passed to one of a plurality of DWDM SFPs 55 (which also form part of the transponder in this example). The DWDM SFPs perform optical to electrical conversion of the signals and amplification of the signals, then the electrical signals are also passed to the FPGA (as shown in more detail in FIG. 6).

FIG. 6 is a detailed schematic diagram of the FPGA. As shown in FIG. 6, a signal from the further portion that corresponds to the selected optical signal is selected by a SERDES 61 (from the electrical signals received by the SERDES from the DWDM SFPs) and is sent to a signal monitoring module 62. This signal from the further portion is to be used as a reference clock signal in the generation of the signal analysis plot, and is also sent to a further SERDES 63 via a phase locked loop (PLL) 64. The further SERDES also receives the electrical version of the input optical signal that is output from the linear SFP. The further SERDES may not be able to recover a reliable clock from the electrical version of the input optical signal; accordingly, the SERDES receiving the further portion works in Clock and Data Recovery (CDR) mode, while the SERDES receiving the electrical version of the input optical signal is set to operate in “lock to reference” mode, and locks to the reference clock signal provided via the PLL. The electrical version of the input optical signal that has been locked to the reference clock is then sent to the signal monitoring module. The signals received by the signal monitoring module are therefore time aligned but not necessarily phase aligned.

The signal monitoring module then acts to phase align the electrical version of the input optical signal and the reference clock signal. The signal monitoring module operates a sweep of all possible delays in order to find the minimum delay. In order to do so, one of the two signals (the electrical version of the input optical signal and the reference clock signal) is shifted and compared to the other of the two signals, for each shift a difference value between the two signals is calculated (for example, a bit-to-bit difference between the two signals). When a minimum of the difference value is found, this may indicate that the two signals are phase aligned.

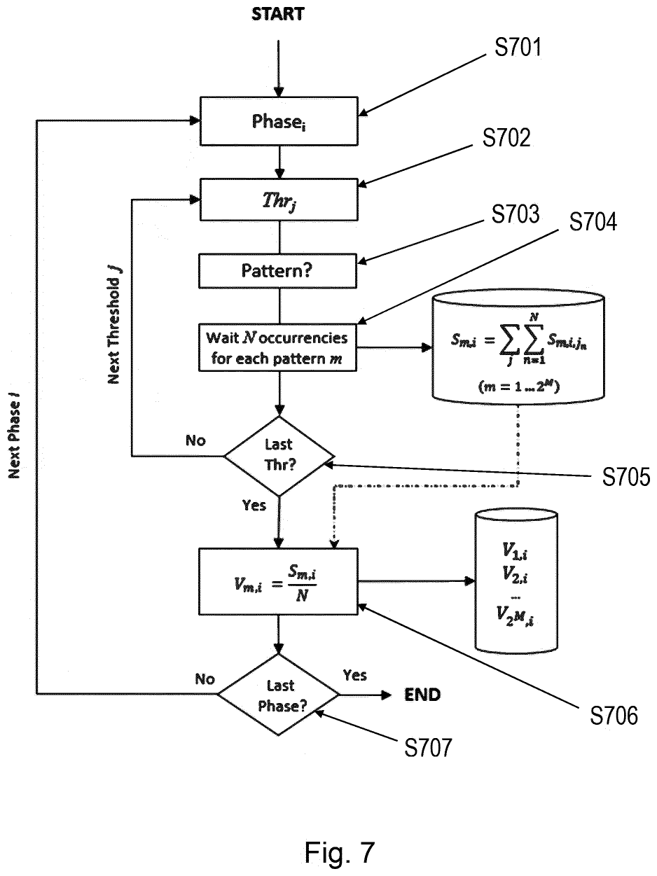

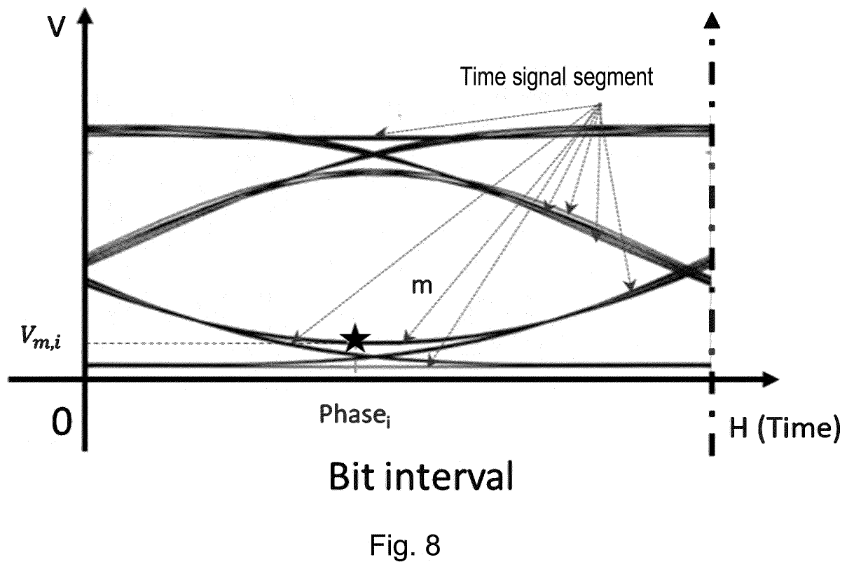

Once the phase alignment has been performed, the signal analysis plot may be completed by the signal monitoring module. In this example, the signal analysis plot is an eye diagram. FIG. 7 is a flowchart explaining how an eye diagram may be generated in accordance with some embodiments. FIG. 7 shows the steps to determine in the eye-diagram the vertical position (V_{m,i}) corresponding to every phase (i) for each one of the optical signal time segments to examine (m ranging from 1 to 2^{M}). A plot that helps illustrate the process of FIG. 7 is shown in FIG. 8.

As shown in step S701, all possible phases i (i.e. all possible horizontal positions within the bit time interval in a quantized format, essentially stepping along the x axis) are explored. FIG. 8 shows a marker indicating Phaseᵢ. For each phase, a set of quantized voltage thresholds Thr are established, as shown in step S702. The presence of an optical signal time segment (bit pattern) is then determined (see step S703), and for each fixed voltage threshold (Thrᵢ) N instances of the optical signal time segment (bit pattern) under analysis are obtained by waiting for N instances of the optical signal to be received and selecting the relevant time segment (see step S704), that is, N instances of the bit pattern are obtained. For each instance of the optical signal time segment under analysis it is determined if the voltage value is below the threshold (Thrⱼ) and a 0 should be assigned to the instance of the optical time signal segment, or 1 if above; the values (0 or 1) for each instance of the optical time signal segment are summed and stored in a memory. For a given phase i, values are obtained for all thresholds (j) (that is, steps S702 to S704 are repeated for the different thresholds j until the last threshold is reached, as shown in step S705). The N values corresponding to the each threshold are then summed and divided by N to obtain the mean value; the mean values for each of the thresholds for a given phase i are then summed; the value obtained is the V_{m,i} value of the eye-diagram, that is, the y value for Phase; and relevant to optical time signal segment m (as shown in step S706). The obtained value is indicated by a star on FIG. 8. The process is then repeated for the next phase (i+1) until all the phases have been processed and values for optical time signal segment m at all phases have been obtained, that is, the average bit pattern is obtained. The process is then repeated for the next optical time signal segment until all optical time signal segments (bit patterns) have been processed and the eye-diagram generated. The resulting eye diagram comprises all of the (averaged) optical time signal segments.

The accuracy of the eye diagram generated may be increased by increasing the number of optical time signal segments (m); and/or increasing the number of instances (N) of the optical time signal segments obtained; and/or increasing the degree of quantization of the y axis (that is, how many phase values i the y axis is divided into). Equally, the processing resources required to generate the eye diagram may be reduced by reducing one or more of m, N and i. The values of m, N and i may therefore be tailored for embodiments depending on the specific signal quality monitoring requirements of said embodiments.

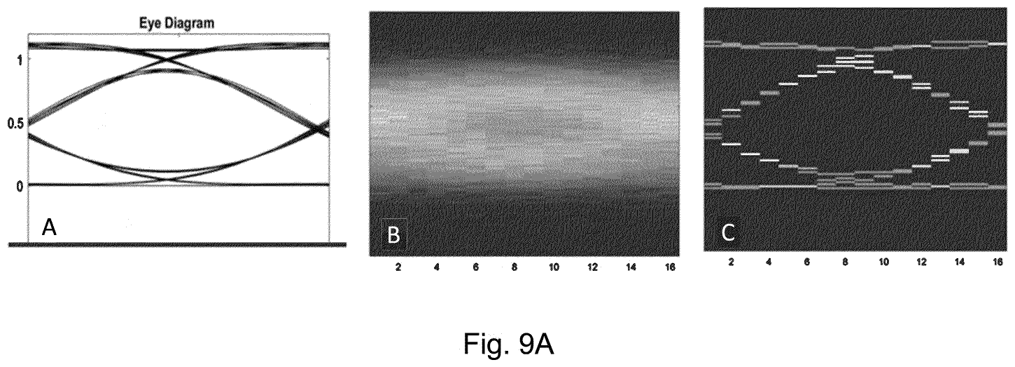

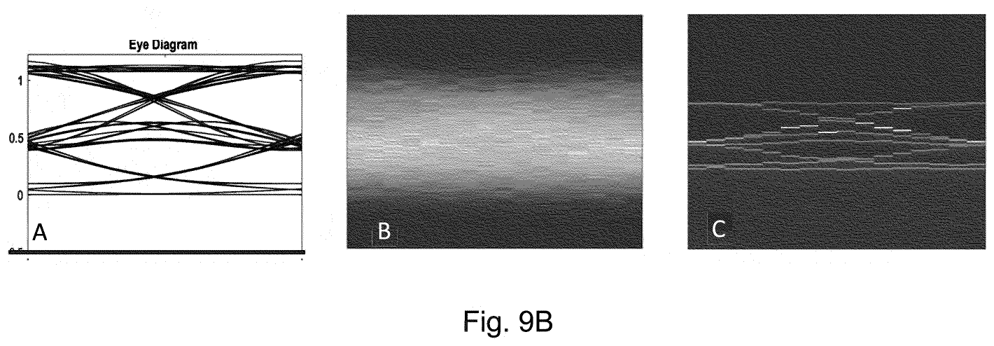

FIG. 9A and FIG. 9B are example simulated signal analysis plots showing how varying the number of instances of optical signal time segments used to generate signal analysis plots (in the FIG. 9A and FIG. 9B examples, eye diagrams) may alter the accuracy of the generated plots. FIG. 9A shows a simulated well open eye, indicative of high signal quality and low bit error rates; this figure was generated using a simulated 25 Gb/s short distance transmission (5 km) on a single mode optical fibre (SMF). FIG. 9B shows a simulated partially closed eye, indicative of lower signal quality and higher bit error rates than FIG. 9A. FIG. 9B was generated using a simulated transmission on 15 km of SMF; dispersion at 25 Gb/s significantly closes the eye as illustrated by the various Inter-Symbol Interference (ISI) crossing lines in FIG. 9B

FIG. 9A and FIG. 9B are both divided into three parts, labelled A, B and C. Part A of each of FIG. 9A and FIG. 9B shows a reference eye diagram; this is the eye diagram which may be obtained in ideal circumstances (assuming no noise, and so on). Part B of each of FIG. 9A and FIG. 9B shows an eye diagram obtained using a method in accordance with embodiments (such as the method of FIG. 7) wherein the number of instances of optical signal time segments used to generate the eye diagram is 1 (that is, N=1). Part C of each of FIG. 9A and FIG. 9B shows an eye diagram obtained using the same method as part B, save that wherein the number of instances of optical signal time segments used to generate the eye diagram is 1024 (that is, N=1024). In the FIG. 9A and FIG. 9B examples, parts B and C have been generated using a pattern of 3 bits (M=3) have been used, 16 phases (16 values of i) and 256 levels of thresholds (256 values of j). The improvement in the accuracy of the eye diagrams shown in part C of both figures relative to the eye diagrams shown in part B of both figures is clear.

By segmenting the optical signal into a plurality of optical signal time segments and then generating the signal analysis plot using the plurality of optical signal time segments, the impacts of noise on the generated plot may be mitigated. The mitigation of noise may be particularly effective where multiple instances of each optical signal time segment are obtained, as this allows an average to be taken and/or outlying segment instances to be excluded, both as discussed above. Accordingly, a signal analysis plot may be obtained from a portion of an incoming transmission at a desired accuracy level, where the portion may potentially comprise a small fraction of the total power of the incoming transmission (thereby not interfering with the use of the remainder of the power of the incoming transmission).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that incorporates an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A signal quality monitoring method for optical signals, the method comprising:
receiving, at a termination point of an optical link an incoming transmission comprising one or more optical signals;
filtering a portion of the incoming transmission to select an optical signal from the one or more optical signals;
segmenting the optical signal by time to obtain a plurality of optical signal time segments;
generating a signal analysis plot using the plurality of optical time signal segments.

2. The method of claim 1, wherein the step of generating the signal analysis plot comprises:
obtaining multiple instances of the plurality of optical signal time segments, the multiple instances of the plurality of optical signal time segments being obtained from different instances of the optical signal separated by time in the incoming transmission;
processing the multiple instances of a given optical signal time segment to generate a processed optical signal segment; and
combining the processed optical signal segment with other processed optical signal segments to generate the signal analysis plot.

3. The method of claim 2, wherein the processed optical signal segment is generated by combining the multiple instances of the corresponding optical signal time segment, and deriving an averaged optical signal time segment as the processed optical signal segment.

4. The method of claim 3, wherein the averaged optical signal segment is derived by calculating:
a mean signal segment from the multiple instances of the corresponding individual optical signal time segment; or
a median signal segment from the multiple instances of the corresponding individual optical signal time segment.

5. The method of claim 2 wherein, prior to utilising the multiple instances the given optical signal time segment to generate the processed optical signal segment, instances of the given optical signal segment that are identified as outliers are excluded from the processed optical signal segment generation process.

6. The method of claim 1, wherein the segmenting of the optical signal by time and generation of the signal analysis plot are performed at a Field Programmable Gate Array, FPGA.

7. The method of claim 6 wherein the FPGA receives the portion of the incoming transmission via a dedicated monitoring port, and wherein the portion of the incoming transmission is a monitoring portion.

8. The method of claim 7, wherein a further portion of the incoming transmission received at the termination point is received by the FPGA via one or more signal ports that are separate from the dedicated monitoring port.

9. The method of claim 8, wherein the further portion of the incoming transmission is the remainder of the incoming transmission.

10. The method of claim 8 wherein, following reception at the dedicated monitoring port, the monitoring portion is converted using an optical to electrical transceiver and the resulting electrical signal is amplified using a linear amplifier.

11. The method of claim 8 wherein the further portion of the incoming transmission is used to provide a reference clock signal for use in the generation of the signal analysis plot.

12. The method of claim 11 wherein the monitoring portion is phase aligned with the further portion prior to the generation of the signal analysis plot.

13. The method of claim 1, further comprising outputting the generated signal analysis plot.

14. The method of claim 13, wherein the signal analysis plot is output to a storage unit, or wherein the signal analysis plot is transmitted to a further apparatus.

15. The method of claim 1, wherein:
the optical signals received at the termination point in the incoming transmission are wavelength division multiplexed optical signals; and
the portion of the incoming transmission is filtered by wavelength to select an optical signal from the wavelength division multiplexed optical signals.

16. A signal quality monitoring system for optical signals, the signal quality monitoring system comprising processing circuitry, one or more interfaces and a memory containing instructions executable by the processing circuitry, whereby the signal quality monitoring system is operable to:
receive, at a termination point of an optical link an incoming transmission comprising one or more optical signals;
filter a portion of the incoming transmission to select an optical signal from the one or more optical signals;
segment the optical signal by time to obtain a plurality of optical signal time segments; and
generate a signal analysis plot using the plurality of optical time signal segments.

17. The signal quality monitoring system of claim 16 operable when generating the signal analysis plot to:
obtain multiple instances of the plurality of optical signal time segments, wherein the multiple instances of the plurality of optical signal time segments are obtained from different instances of the optical signal separated by time in the incoming transmission;
process the multiple instances of a given optical signal time segment to generate a processed optical signal segment; and
combine the processed optical signal segment with other processed optical signal segments to generate the signal analysis plot.

18. The signal quality monitoring system of claim 17, operable to generate the processed optical signal segment by combining the multiple instances of the corresponding optical signal time segment, and deriving an averaged optical signal time segment as the processed optical signal segment.

19. The signal quality monitoring system of claim 17, operable to derive the averaged optical signal segment by calculating:
a mean signal segment from the multiple instances of the corresponding individual optical signal time segment; or
a median signal segment from the multiple instances of the corresponding individual optical signal time segment.

20. The signal quality monitoring system of claim 17 operable to exclude instances of the given optical signal segment that are identified as outliers from the processed optical signal segment generation process prior to utilising the multiple instances the given optical signal time segment to generate the processed optical signal segment.

21-30. (canceled)
